(19) United States
(12) Patent Application Publication
(10) Pub. No.: US 2007/0014948 A1
(43) Pub. Date: Jan. 18, 2007

(54) Laser-cleanable winding cores and cleaning method therefor

(75) Inventor: Brian P. Couchey, Inman, SC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Sonoco Development, Inc.

(21) Appl. No.: 11/180,851

(22) Filed: Jul. 13, 2005

(51) Int. Cl. B32B 27/10

(52) U.S. Cl. 428/34.2

(57) ABSTRACT

A winding core has an outer surface that is reflective for reflecting a laser beam used for cutting through residual material wound about the core so that the core can be reused for winding new material. A cleaning method entails using a laser beam to cut through residual material wound about a core, and reflecting the laser beam from a reflective outer surface of the core so as to prevent damage to the core.

### BACKGROUND OF THE INVENTION

The present invention relates to winding cores onto which yarn, filament, plastic film, paper, and like products are wound.

Products such as those noted above are typically supplied in the form of rolls wound about a tubular carrier or support generally referred to herein as a winding core. The product wound about the winding core is subsequently unwound and used in a process. Often there is a desire to reuse the winding core for winding a new roll. Frequently, however, some amount of the old product remains on the core after the unwinding operation. Before the winding core can be reused, all of the old product must be removed from the core.

Currently, various method are used for removing the old product from winding cores. One technique is to manually remove the material by first using a knife to cut through the layers of the material and then using a tool called a plough to separate the material from the core. A hot knife is sometimes used to melt through thermoplastic material such as plastic film or synthetic yarn. There are also automated guillotines and cutters that can be used for removing the old product. These various tools and methods entail a high likelihood that damage will be done to the outer surface of the core. If the damage is too extensive, the core must be scrapped. Even if the damage is judged as not necessitating the scrapping of the core, the damage nonetheless can cause the product wound onto the core to be deleteriously affected such as by marking from damaged areas of the core surface.

### BRIEF SUMMARY OF THE INVENTION

The present invention addresses the above needs and achieves other advantages by providing a winding core in which at least a portion of the outer surface of the core is reflective for reflecting a laser beam without being damaged by the beam. Accordingly, the core can be cleaned of old material by directing a laser beam onto the material to cut through the material, the beam reflecting off the reflective outer surface of the core. The cut material then either falls away on its own under the influence of gravity or can be urged away from the core by an air jet or by mechanical assistance.

In accordance with one embodiment of the invention, a winding core comprises a tubular core wall that has an inner surface and an outer surface and is formed of a material comprising a thermoplastic or thermoset polymer. At least a portion of the outer surface of the polymer core wall is reflective. The reflectivity can be accomplished in various ways. As one example, a reflective tape can be affixed to the outer surface of the core wall. The tape can cover only a portion of the outer surface; for instance, the tape can comprise an axially extending strip that spans the length of the core wall but only a portion of the circumference of the wall.

In another embodiment, the outer surface of the core wall can be painted or sprayed with a reflective material such as a metallic paint or ink. The reflective material can cover the entire outer surface or only a portion thereof.

As still another alternative, a metal foil or metallized film can be wrapped about the outer surface of the core wall to provide the desired reflectivity. For example, a reflective shrink sleeve can be sleeved over the core wall and then heated to shrink the sleeve about the core.

In a further embodiment of the invention, the polymer core wall includes reflective material incorporated into the polymer during the process of forming the wall. Such reflective materials can include flaked aluminum or the like. The core is formed by injection molding or extruding the polymer containing the reflective material.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a perspective view of a winding core in accordance with a first embodiment of the invention;

FIG. 2 is a fragmentary perspective view of a core in accordance with a second embodiment of the invention;

FIG. 3 is a cross-sectional view through the core of FIG. 2 along line 3-3;

FIG. 4 is a fragmentary cross-sectional view, on an enlarged scale, of a plastic winding core in accordance with a third embodiment of the invention; and

FIG. 5 is a schematic depiction of an apparatus for cleaning cores in accordance with one embodiment of the invention.

### DETAILED DESCRIPTION OF THE INVENTION

The present inventions now will be described more fully hereinafter with reference to the accompanying drawings, in which some but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

In accordance with the present invention, winding cores are made laser-cleanable by providing a reflective surface for reflecting a laser beam used for cutting through residual material wound about the core. As described below, the winding cores can be of various materials and constructions, and the reflective surface can be provided in various ways.

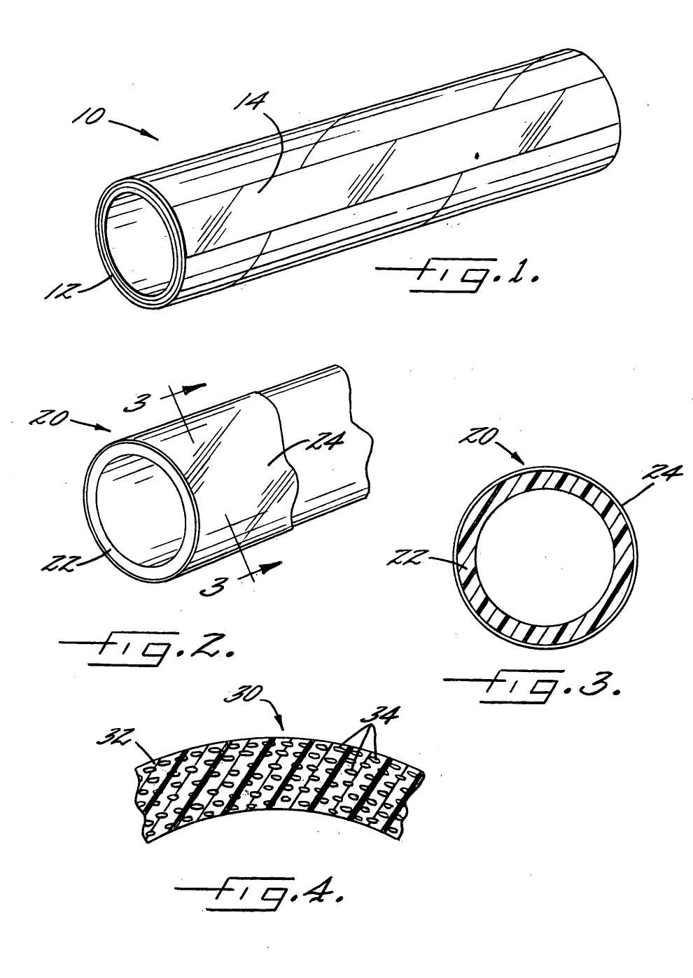

FIG. 1 shows a winding core 10 in accordance with a first embodiment of the invention. The winding core comprises a wound paperboard tube 12. The tube can be spirally wound as shown. More particularly, a plurality of paperboard plies are spirally wrapped one upon another about a cylindrical mandrel and adhered together with a suitable adhesive applied to the plies, thus forming a continuous paperboard tube that is cut into lengths appropriate for the particular application. The winding core 10 includes a reflective strip 14 disposed on the radially outer surface of the paperboard tube 12. The reflective strip can be of various materials and constructions. As one example, the strip 14 can comprise a metal foil layer with a layer of pressure-sensitive adhesive disposed on its lower surface, and optionally can include a further layer such as paper or polymer film between the foil and the adhesive layer to impart tear-resistance to the tape. Alternatively, the strip can comprise a strip of metallized polymer film having a pressure-sensitive adhesive on its lower surface, wherein the vapor-deposited metal layer is on the upper surface of the tape. As shown, the strip extends along the full length of the tube 12 but extends about only a portion of the circumference.

The tube 12 is shown and described as comprising a paperboard tube, but alternatively the tube can be formed of different material such as a thermoplastic or thermoset polymer. For example, the tube can be extruded from a thermoplastic polymer, or can be pultruded to include fibers for structural reinforcement. The tube can be formed of a combination of materials, such as an inner shell of wound paperboard and an outer shell of polymer extruded or pultruded over the paperboard shell. Other tube constructions can also be used. The particular construction of the tube is not critical to the present invention.

Other constructions and materials for the reflective strip 14 can also be used. For example, the strip 14 can comprise a strip of reflective material such as reflective paint or reflective ink applied to the outer surface of the tube 12. Such reflective paints and inks, also referred to as metallic paints and inks, generally comprise a metallic pigment and a liquid resin system or “varnish” that serves as a carrier for the pigment and protects it after drying. Silver ink pigments typically comprise aluminum particles in various proportions. The metallic pigment essentially consists of flakes or particles of metal from about 3 microns to about 25 microns in size, and preferably about 10-15 microns. Generally, the larger the particle size, the more reflectance or brilliance the printed ink film will display. The metallic inks useful in the present invention can be either “leafing” or “non-leafing” inks, although the latter type is preferred. In a leafing ink, the metallic particles are coated with a fatty acid during processing, which causes the particles to rise to the surface of the printed ink film and orient themselves into a flat and reflective surface. The disadvantage of leafing inks is that the metallic flakes tend to rub off. In a non-leafing ink, the metallic particles tend to sink to the bottom of the ink film adjacent the substrate and thus are not susceptible to rubbing off, but the downside is that the ink has less reflectivity because the particles tend not to align into a flat surface and because light has to penetrate the varnish before reflecting from the particles.

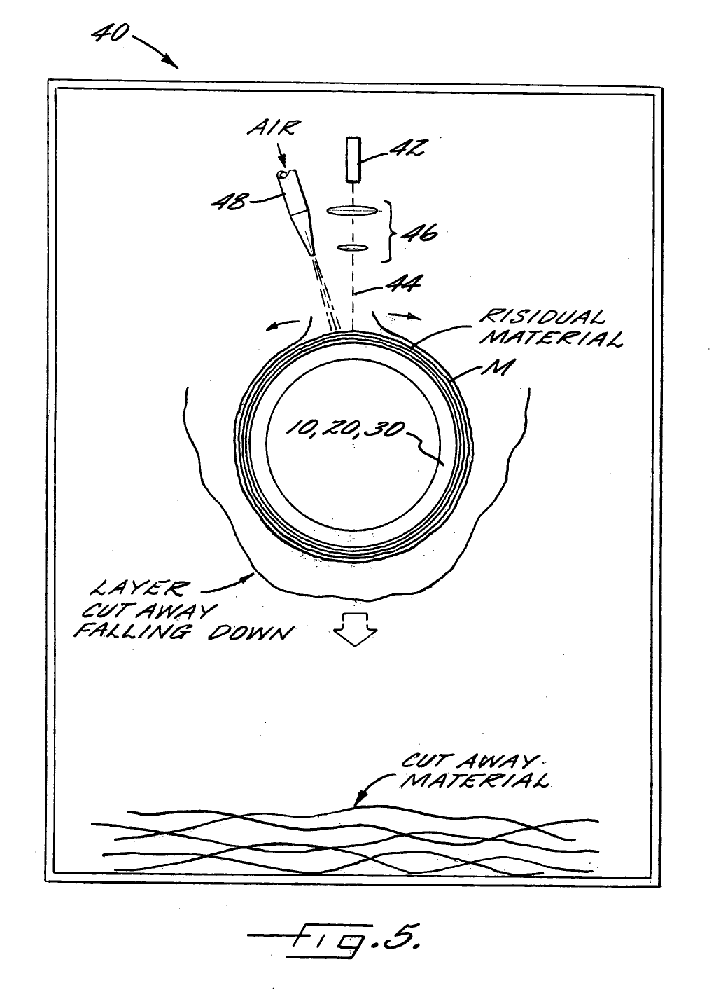

A winding core 20 in accordance with another embodiment of the invention is illustrated in FIGS. 2 and 3. The winding core comprises a polymer tube 22 and a reflective shrink sleeve 24 fit snugly about the outer surface of the polymer tube. The reflective shrink sleeve 24 comprises a heat-shrinkable polymer film tube. The outer surface of the sleeve is made reflective, such as by vapor-depositing a thin layer of metal onto (i.e., metallizing) the outer surface. The sleeve prior to heat-shrinking is slightly larger in diameter than the tube 22. The sleeve is then heated to shrink the sleeve so that it snugly fits about the outer surface of the tube.

The tube 22 is described and shown as a polymer tube, but other tube constructions can be used. For instance, the tube can comprise a wound paperboard tube, or a pultruded tube, or a composite paperboard/polymer tube, as previously described.

A winding core 30 in accordance with a third embodiment of the invention is shown in FIG. 4. The winding core comprises a polymer tube 32 formed of a polymer material that contains flakes or particles 34 of reflective material. The reflective particles, for example, can comprise aluminum. The reflective particles 34 are present in sufficient concentration in the polymer matrix so that the outer surface of the tube 32 is reflective of a laser beam used for cutting through residual wound material on the core.

Variations on the above-described winding cores can be made in accordance with the invention. For example, a paperboard or polymer tube can be made reflective by spraying or otherwise applying a reflective or metallic paint or ink over the entire outer surface of the core, rather than only along a strip as in FIG. 1. As another example, an outer shell of polymer containing reflective particles can be extruded onto the outer surface of a paperboard tube.

FIG. 5 diagrammatically depicts a cleaning method in accordance with one embodiment of the invention. A winding core 10, 20, 30 having residual wound material M thereon is placed within a chamber or enclosure 40. The core can be disposed in various orientations, although it may be advantageous to orient the core in a generally horizontal orientation as shown so that gravity will aid in urging the residual material away from the core after the material is cut. A laser 42 is positioned above the core. If the core has a reflective strip that extends only partially about the core's circumference (as in FIG. 1), the core is positioned such that the reflective strip is at the top facing the laser. The laser is operated to emit a beam 44 of coherent light, which can be conditioned by various optics 46 as required to produce a beam of suitable width and to focus the beam onto the residual material M. The beam preferably is scanned linearly along the length of the core to cut through the residual material along its full length. The beam may cut through the residual material one layer (or more than one layer) at a time, and the beam can be scanned multiple times along the length, if necessary, in order to cut through all layers of the residual material. A sensor (not shown) can detect the reflection of the laser beam from the reflective outer surface of the core when the beam has penetrated all the way through the residual material, such that the sensor's signal can be used for determining when the cutting process should be stopped. The reflective surface of the core substantially prevents the laser beam from damaging the core surface, such that the core is suitable for reuse.

As the layers are severed, gravity in some cases may be sufficient to urge the layers away from the core, such that the cut layers fall down into a lower region of the enclosure for collection and disposal. Alternatively, various techniques can be employed to assist in removing the cut residual material. For example, as shown in FIG. 5, an air nozzle 48 can be used to direct an air jet against the cut residual material to assist in urging the material away from the core. In other cases, mechanical devices (not shown) can be used to urge the cut material away from the core.

After all of the residual material has been removed from the core, the core is ready to be reused in a winding operation. Cores made in accordance with the invention potentially can be reused multiple times.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method for cleaning a winding core to remove residual material therefrom, the method comprising the steps of:
providing the winding core with a reflective outer surface onto which the residual material is wound;
directing a laser beam onto the residual material overlying the reflective outer surface so as to cut through the residual material, the laser beam reflecting off the reflective outer surface when the beam penetrates completely through the residual material, the reflective outer surface thereby substantially preventing the laser beam from damaging the winding core; and
urging the cut residual material away from the winding core.

2. The method of claim 1, wherein the providing step comprises providing the reflective outer surface along substantially the entire length and about substantially the entire circumference of the winding core.

3. The method of claim 1, wherein the providing step comprises providing the reflective outer surface along substantially the entire length of the winding core but about only a portion of the circumference of the winding core.

4. The method of claim 3, wherein the winding core is oriented horizontally with the reflective outer surface facing upwardly.

5. The method of claim 1, wherein the urging step comprises allowing gravity to pull the cut residual material away from the winding core.

6. The method of claim 1, wherein the urging step comprises using forced air to urge the cut residual material away from the winding core.

7. A laser-cleanable winding core, comprising:
a tubular core wall having a radially inner surface and a radially outer surface, and having a length extending between opposite ends of the core wall;
wherein the radially outer surface comprises a reflective surface extending along substantially the entire length of the core wall, the reflective surface having sufficient reflectivity to reflect a laser beam used for cutting through residual material wound atop the reflective surface such that the reflective surface substantially prevents the laser beam from damaging the winding core.

8. The laser-cleanable winding core of claim 7, wherein the core wall comprises paperboard and the reflective surface comprises a reflective tape adhered to the radially outer surface of the core wall.

9. The laser-cleanable winding core of claim 7, wherein the reflective surface extends about only a portion of the circumference of the core wall.

10. The laser-cleanable winding core of claim 7, wherein the core wall comprises plastic.

11. The laser-cleanable winding core of claim 10, wherein the reflective surface comprises a reflective layer wrapped about the plastic core wall.

12. The laser-cleanable winding core of claim 11, wherein the reflective layer comprises a reflective shrink sleeve that is heat-shrunk about the plastic core wall.

13. The laser-cleanable winding core of claim 7, wherein the core wall comprises paperboard and the reflective layer comprises a reflective shrink sleeve that is heat-shrunk about the core wall.

14. The laser-cleanable winding core of claim 7, wherein the core wall comprises plastic containing reflective particles or flakes for providing the reflective surface.

15. The laser-cleanable winding core of claim 7, wherein the reflective surface is provided by reflective paint or ink applied to the radially outer surface of the core wall.

16. The laser-cleanable winding core of claim 7, wherein the reflective surface is provided by a metal foil. 17. The laser-cleanable winding core of claim 7, wherein the reflective surface is provided by a metallized polymer film.
